(19) United States
(12) Patent Application Publication
(10) Pub. No.: US 2016/0230993 A1
(43) Pub. Date: Aug. 11, 2016

(54) COMBUSTOR LINER EFFUSION COOLING HOLES

(71) Applicant: UNITED TECHNOLOGIES CORPORATION, Hartford, CT (US)

(72) Inventors: ZHONGTAO DAI, Manchester, CT (US); MATTHEW R. PEARSON, Hartford, CT (US); JEFFREY M. COHEN, Hebron, CT (US)

(73) Assignee: UNITED TECHNOLOGIES CORPORATION, Hartford, CT (US)

(21) Appl. No.: 14/618,087

(22) Filed: Feb. 10, 2015

(51) Int. Cl. F23R 3/00

(52) U.S. Cl. CPC F23R 3/002; F23R 2900/03041; F23R 2900/03044; B33Y 80/00

(57) ABSTRACT

A gas turbine engine component may be manufactured by an additive manufacturing process. The component may be a combustor liner. The combustor liner may include nonlinear cooling holes. The cooling holes may have an increased length compared to conventional linear cooling holes. The longer cooling holes may increase the amount of heat transfer from the combustor liner to the cooling air flowing through the cooling holes.

### FIELD

The disclosure relates generally to gas turbine engines, and more particularly to effusion cooling holes in gas turbine engines.

### BACKGROUND

Gas turbine engines typically comprise compressor stages which feed compressed air to a combustor. A portion of the compressed air is mixed with fuel and ignited in the combustor. A portion of the compressed air is directed through cooling holes in the combustor and protects the combustor from the high temperatures caused by the combustion. The cooling holes are typically drilled through the combustor liner, at an angle relative to the combustor liner. The holes are typically linear, as it is difficult to create complex hole shapes with known drilling techniques. The loss or pressure drop across the linear holes is generally small and fixed so that it is difficult to increase the number density of the holes without increasing the cooling flow. Therefore, the spacing and pitch distance for the linear holes are generally very large, resulting in poor film cooling effectiveness. In addition, compared to the liner backside or impingement convective cooling, the convective cooling within the linear effusion holes is generally small due to small surface area, which is related to the number, passage length, and diameter of the holes.

There is continuous effort to reduce the cooling flow of the combustor liner in order to improve combustor performance. In recent times, gas turbine engines have been designed with higher overall pressure ratios (“OPR”). The temperature of the cooling air in these high OPR engines is higher compared to engines with lower OPRs. The higher temperature of the cooling air results in less heat transfer from the combustor liner to the cooling air. A larger portion of the compressed air may be utilized for cooling air, which significantly impacts combustor design and combustor performance.

### SUMMARY

A gas turbine engine component may comprise an outer surface of a first wall, an inner surface of the first wall, and a first cooling hole extending from the outer surface of the first wall to the inner surface of the first wall. The first cooling hole may be nonlinear.

In various embodiments, the gas turbine engine component may be manufactured by an additive manufacturing process. The first cooling hole may comprise a first straight passage connected to a second straight passage by a first bend. The first straight passage may be parallel to the second straight passage. The gas turbine engine component may be a combustor liner. A length of the first cooling hole may be at least twice a thickness of the combustor liner. The gas turbine engine component may comprise a second wall comprising a second cooling hole, wherein the second cooling hole is configured to direct cooling air to the first wall. The second cooling hole may be a linear cooling hole. The combustor liner may comprise a segmented wall coupling the first wall to the second wall.

A combustor for a gas turbine engine may comprise a first wall comprising a first cooling hole, wherein the cooling hole comprises an inlet, a first straight passage connected to the inlet by a first bend, and a second straight passage connected to the first straight passage by a second bend.

In various embodiments, the combustor may be manufactured by an additive manufacturing process. A length of the first cooling hole may be at least five times a thickness of the first wall. The combustor may comprise a second wall comprising an impingement hole, wherein the impingement hole is configured to direct cooling air to the first wall. The impingement hole may be a linear cooling hole. The combustor liner may be a single-wall liner comprising the first wall, a second wall, and a segmented wall between the first wall and the second wall. A combustor liner may comprise the first wall only as a single-wall liner. A combustor liner may also comprise both the first and second wall with these two walls bolted together. In addition, using additive manufacturing process or welding, a combustor liner may be built as a single-wall liner by adding a segmented wall to combine the first and second wall together.

A combustor liner may be manufactured by an additive manufacturing process. The combustor liner may comprise a nonlinear cooling hole.

In various embodiments, the nonlinear cooling hole may extend through a first wall of the combustor liner. A length of the cooling hole may be at least five times a thickness of the first wall. The combustor liner may be a single-wall liner comprising the first wall, a second wall, and a segmented wall between the first wall and the second wall. The cooling hole may comprise an inlet, a first straight passage connected to the inlet by a first bend, a second straight passage connected to the first straight passage by a second bend, a third straight passage connected to the second straight passage by a third bend, and an outlet connected to the third straight passage by a fourth bend.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 illustrates a schematic cross-section view of a gas turbine engine in accordance with various embodiments;

FIG. 2A illustrates a perspective view of a combustor in accordance with various embodiments;

FIG. 2B illustrates a perspective view of a turbine vane in accordance with various embodiments;

FIG. 3A illustrates a perspective view of a single-wall combustor liner in accordance with various embodiments;

FIG. 3B illustrates a perspective view of a cooling hole in a combustor liner in accordance with various embodiments;

FIG. 4 illustrates a perspective view of a double-wall combustor liner in accordance with various embodiments;

FIG. 5 illustrates a perspective view of a single-wall combustor liner with segmented walls in accordance with various embodiments; and

FIG. 6 illustrates a detailed view the single-wall combustor liner of FIG. 5.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

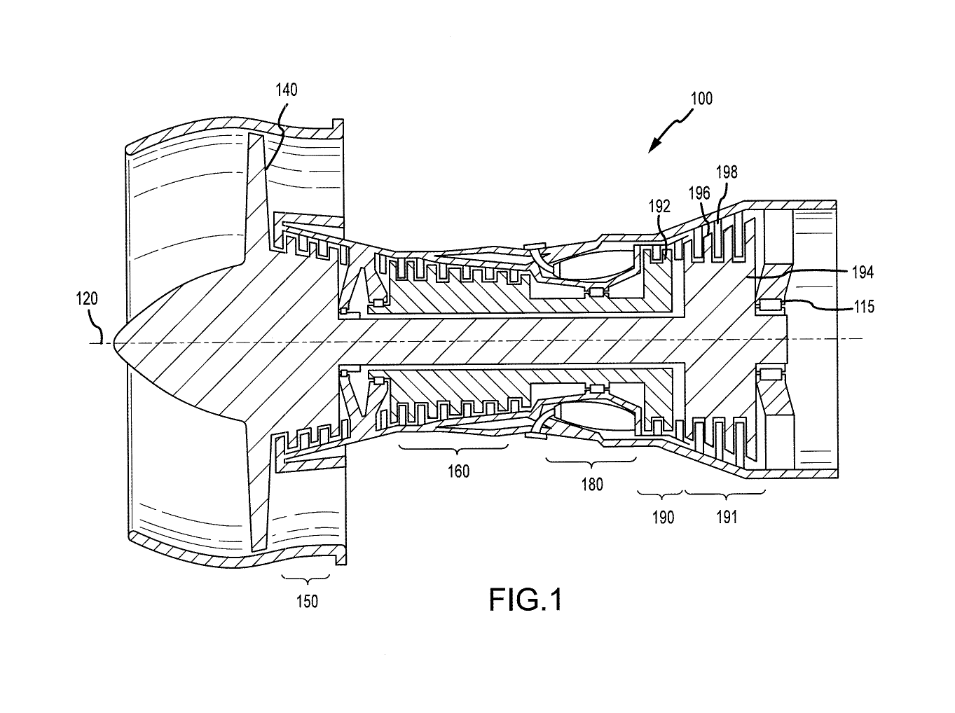

Referring to FIG. 1, a gas turbine engine 100 (such as a turbofan gas turbine engine) is illustrated according to various embodiments. Gas turbine engine 100 is disposed about axial centerline axis 120, which may also be referred to as axis of rotation 120. Gas turbine engine 100 may comprise a fan 140, compressor sections 150 and 160, a combustion section 180 including a combustor, and turbine sections 190, 191. Air compressed in the compressor sections 150, 160 may be mixed with fuel and burned in combustion section 180 and expanded across the turbine sections 190, 191. The turbine sections 190, 191 may include high pressure rotors 192 and low pressure rotors 194, which rotate in response to the expansion. The turbine sections 190, 191 may comprise alternating rows of rotary airfoils or blades 196 and static airfoils or vanes 198. Cooling air may be supplied to the combustor and turbine sections 190, 191 from the compressor sections 150, 160. A plurality of bearings 115 may support spools in the gas turbine engine 100. FIG. 1 provides a general understanding of the sections in a gas turbine engine, and is not intended to limit the disclosure. The present disclosure may extend to all types of turbine engines, including turbofan gas turbine engines and turbojet engines, for all types of applications.

The forward-aft positions of gas turbine engine 100 lie along axis of rotation 120. For example, fan 140 may be referred to as forward of turbine section 190 and turbine section 190 may be referred to as aft of fan 140. Typically, during operation of gas turbine engine 100, air flows from forward to aft, for example, from fan 140 to turbine section 190. As air flows from fan 140 to the more aft components of gas turbine engine 100, axis of rotation 120 may also generally define the direction of the air stream flow.

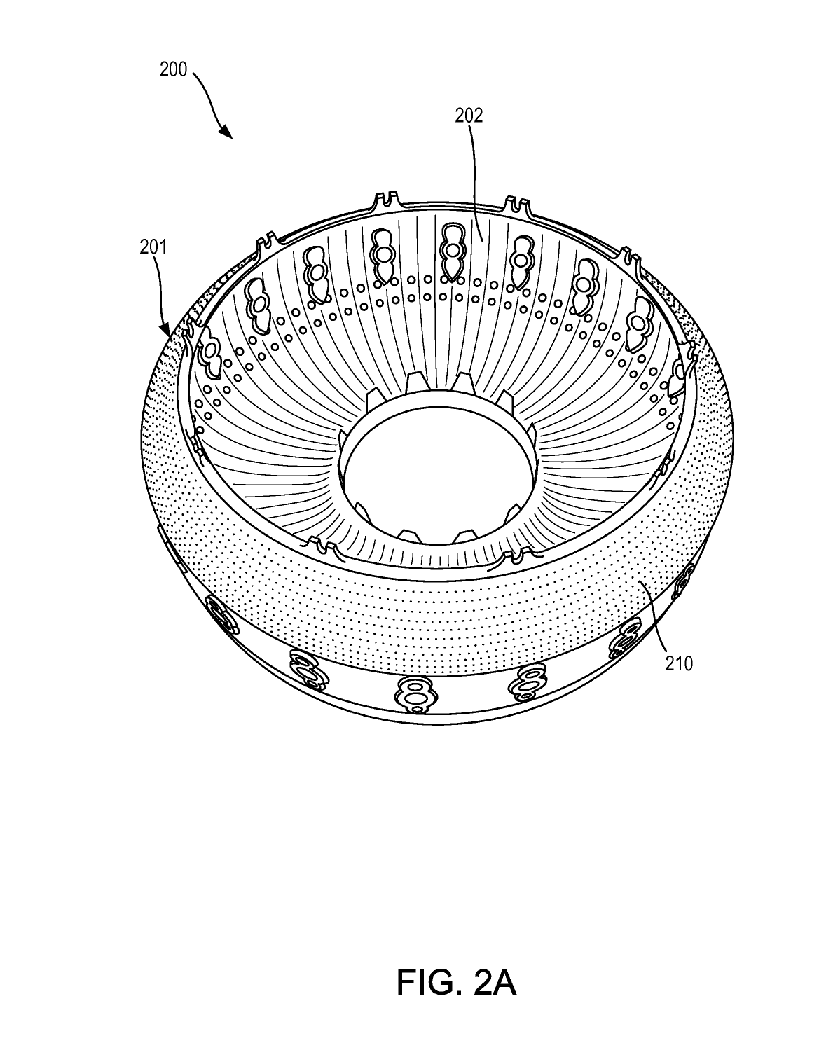

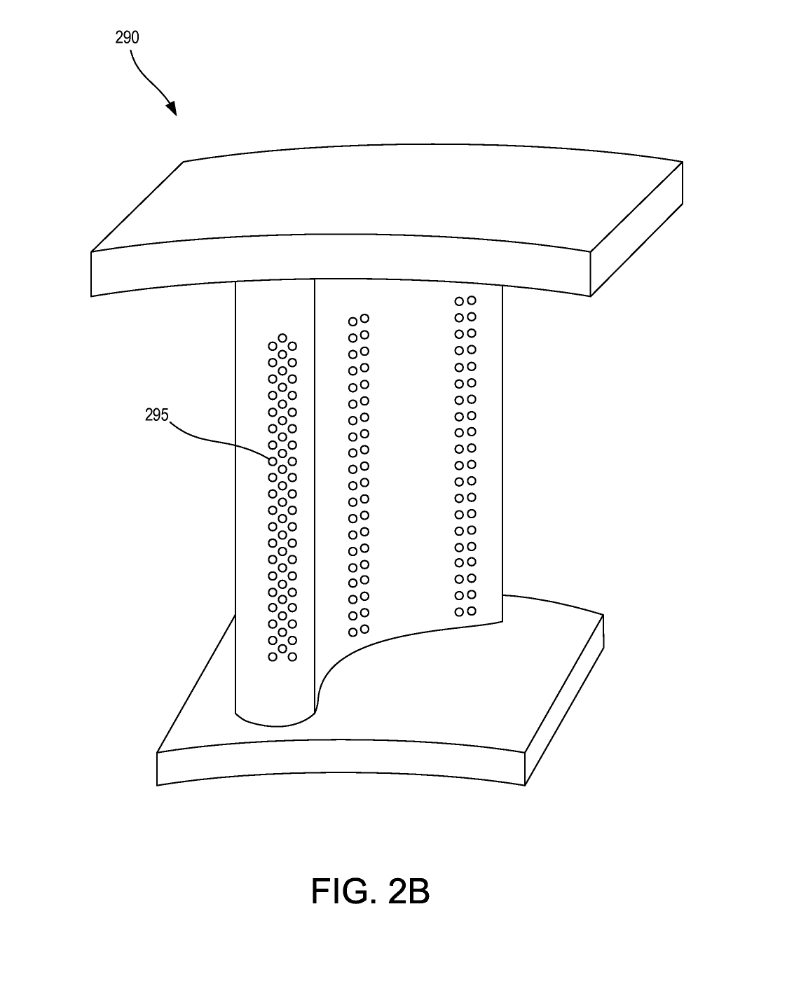

Referring to FIG. 2A, a perspective view of a combustor liner 200 is illustrated according to various embodiments. The combustor liner 200 may be generally annular. The combustor liner 200 may be a combustor for a high overall pressure ratio (“OPR”) engine. The overall pressure ratio is the ratio of the stagnation pressure at the front and rear of the compressor section of the gas turbine engine. In general, engines with higher OPRs will have higher efficiencies. As used herein, a high OPR engine refers to a gas turbine engine with an OPR of 15:1 or higher. However, those skilled in the art will recognize that the concepts disclosed herein are not limited to high OPR engines.

The combustor liner 200 may comprise cooling holes 210. Cooling air from the last compressor stage may impinge on the outer surface 201 of the combustor liner 200. The cooling air may flow through the cooling holes 210. Heat may transfer from the combustor liner 200 to the cooling air as the cooling air travels through the cooling holes 210. The cooling air may then flow along the inner surface 202 and create a film cooling layer along the inner surface 202.

In high OPR engines, the temperature of the cooling air may be 1300° F. (700° C.) or greater. In combustors with conventional drilled cooling holes, the heat transfer from the combustor liner 200 to the cooling air in the cooling holes may be decreased due to the higher temperature of the cooling air.

Recent advances in additive manufacturing techniques allows for the construction of combustors with complex shapes. The combustor liner 200 may be manufactured by an additive manufacturing process, such as direct metal laser sintering (“DMLS”). DMLS may comprise fusing metal powder into a solid part by melting it locally using a laser. Using DMLS or other additive manufacturing techniques to manufacture the combustor liner 200 may allow the cooling holes 210 to be nonlinear. As used herein, a nonlinear cooling hole refers to a cooling hole that causes the cooling air to change direction as the cooling air flows through the nonlinear cooling hole.

Although described herein primarily with reference to combustor liners, those skilled in the art will appreciate that many gas turbine engine components or other components which utilize effusive cooling may be manufactured with nonlinear cooling holes using an additive manufacturing process. For example, referring to FIG. 2B, a turbine vane 290 is illustrated with nonlinear cooling holes 295. The turbine vane 290 may be manufactured by an additive manufacturing process. Cooling air may flow through the nonlinear cooling holes 295 from the interior to the exterior of the turbine vane 290 to cool the turbine vane. Blades, vanes, airfoils, and combustors are merely a few examples of components that may be manufactured with nonlinear cooling holes.

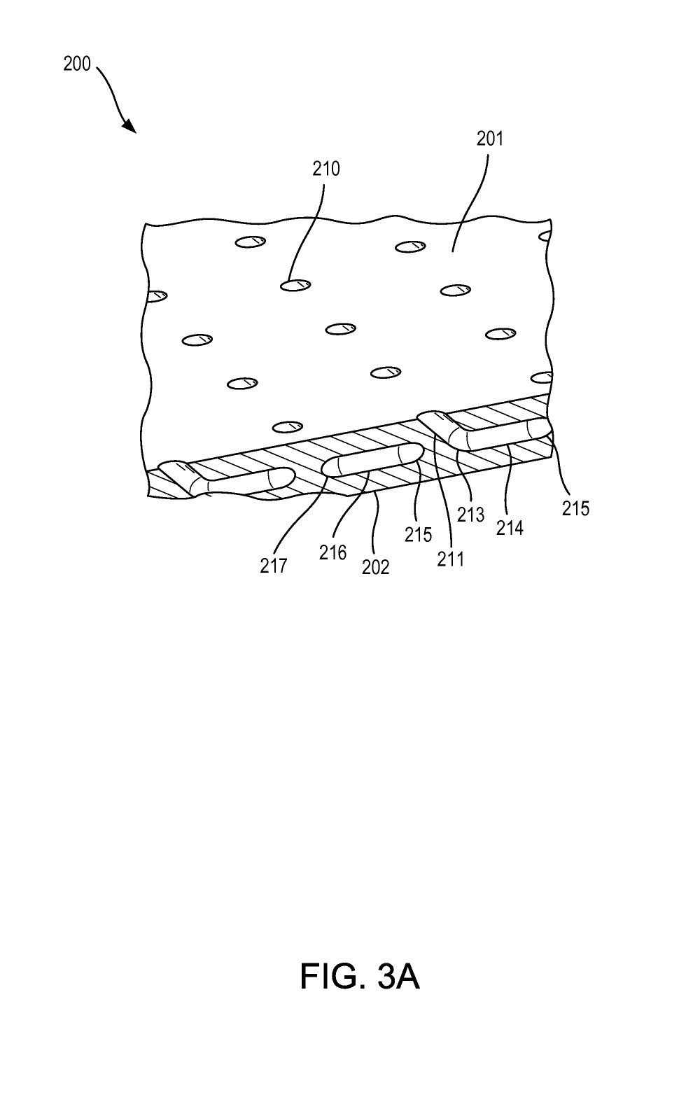

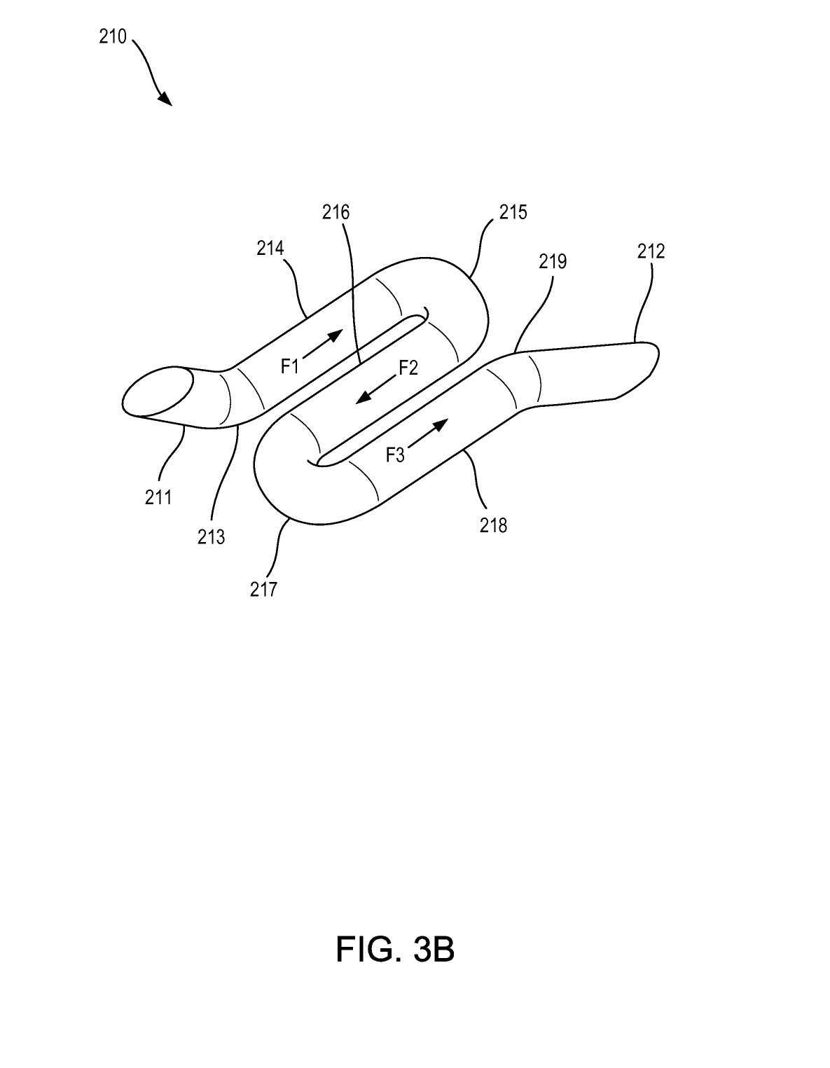

Referring to FIGS. 3A and 3B, a perspective view of the combustor liner 200 with cooling holes 210 is illustrated in FIG. 3A, and a perspective view of a cooling hole 210 is illustrated in FIG. 3B according to various embodiments. Cooling air may impinge on the outer surface 201 of the combustor liner 200. The cooling air may enter the cooling holes 210 through the inlets 211, travel through the cooling holes 210, and exit the cooling holes through the outlets 212 at the inner surface 202 of the combustor liner 200. As the cooling air travels through the cooling holes 210, heat is transferred from the combustor liner 200 to the cooling air. After exiting the outlets 212, the cooling air forms a film cooling layer along the inner surface 202 of the combustor liner 200. The cooling holes 210 may be manufactured with a variety of cross-sectional shapes. Although illustrated with a circular cross-sectional shape, the cross-sectional shape may be square, square with rounded corners, ovoid, or any other suitable shape.

Using additive manufacturing for manufacturing the combustor liner 200 allows for the cooling holes 210 to be formed in complex shapes. Those skilled in the art will recognize that an infinite number of nonlinear hole shapes may be consistent with the present disclosure, and the shape illustrated in FIGS. 3A and 3B is merely one example of a nonlinear cooling hole. Nonlinear cooling holes may comprise any number of straight passages or bends, and the inlets and outlets for nonlinear cooling holes may be coupled to the straight passages or bends at any suitable angles. The cooling holes 210 may comprise an inlet 211 which is formed at an acute angle relative to the outer surface 201. The cooling holes 210 may comprise a first bend 213 connecting the inlet 211 to a first straight passage 214. The first straight passage 214 may be parallel to the outer surface 201 and/or the inner surface 202. The first straight passage 214 may be connected to a second straight passage 216 by a second bend 215. The second bend 215 may be a 180° turn, such that the second straight passage 216 is parallel to the first straight passage 214. The direction of flow F2 in the second straight passage 216 may be opposite to the direction of flow F1 in the first straight passage 214. The second straight passage 216 may be connected to a third straight passage 218 by a third bend 217. The third bend 217 may be a 180° turn, such that the second straight passage 216 is parallel to the third straight passage 218. The direction of flow F2 in the second straight passage 216 may be opposite to the direction of flow F3 in the third straight passage 218. The third straight passage 218 may be connected to the outlet 212 via a fourth bend 219. The outlet 212 may form an acute angle with the inner surface 202. The cooling air may remove heat from the combustor liner 200 as the cooling air travels through the cooling holes 210.

The cooling holes 210 may have a longer flow path (the path of the cooling air through the cooling holes 210) than straight drilled cooling holes. The cooling holes 210 may have an increased length as compared to conventional linear drilled cooling holes. In various embodiments, the length of the cooling holes 210 may be at least twice the thickness T of the combustor liner. However, in various embodiments, the length of the cooling holes may be at least 5 times, or at least 10 times the thickness T. Such ratios may not be possible with conventional drilled cooling holes. The increased length may increase the surface area of the cooling holes 210, and increase the amount of heat transferred from the combustor liner 200 to the cooling air in the cooling holes 210. Additionally, the increased length may increase the pressure drop across each cooling hole 210, e.g. four times compared with linear holes, which may allow for the combustor liner 200 to be manufactured with more cooling holes 210 than a combustor with linear cooling holes. In various embodiments, the length of the flow path through the cooling holes 210 may be at least twice as long as the distance between the inlet 211 and the outlet 212. The cooling holes 210 may also have a larger surface area as compared to straight cooling holes, which may increase the amount of heat transferred from the combustor liner 200 to the cooling air. Therefore, if keeping the same number density as straight holes, the cooling flow will be significantly reduced while still being effective.

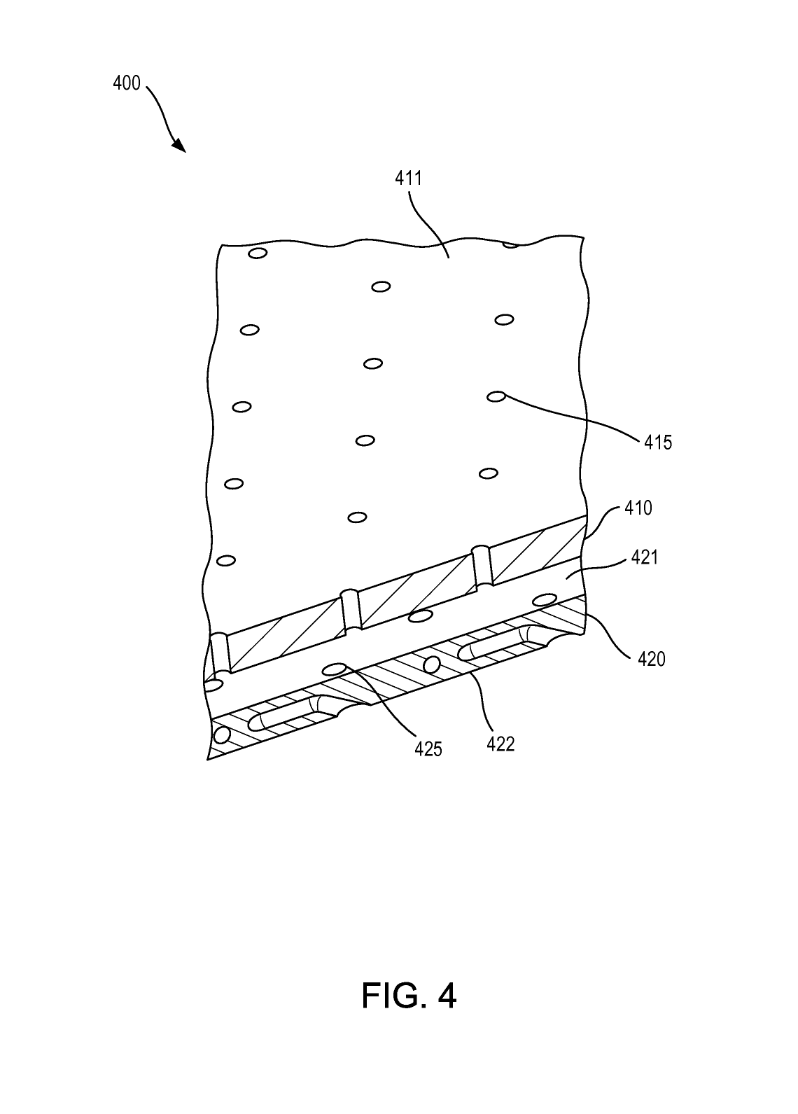

Referring to FIG. 4, a double-walled combustor liner 400 is illustrated according to various embodiments. The double-walled combustor liner 400 may comprise an outer wall 410 and an inner wall 420. The outer wall 410 may also be referred to as the “cold wall,” and the inner wall 420 may also be referred to as the “hot wall.” The outer wall 410 may comprise impingement holes 415. In various embodiments, the impingement holes 415 may be linear cooling holes formed by a drilling process. The impingement holes 415 may be perpendicular to the outer surface 411. Cooling air may impinge on the outer surface 411 of the outer wall 410. The cooling air may flow through the impingement holes 415. Heat may be transferred from the outer wall 410 to the cooling air in the impingement holes 415. After travelling through the impingement holes 415, the cooling air may impinge on the outer surface 421 of the inner wall 420. The inner wall 420 may comprise cooling holes 425. The cooling holes 425 may be nonlinear cooling holes, as previously described with reference to FIGS. 3A-3B. The cooling air may travel through the cooling holes 425 and absorb heat from the inner wall 420. The cooling air may create a film cooling layer on the inner surface 422 of the inner wall 420.

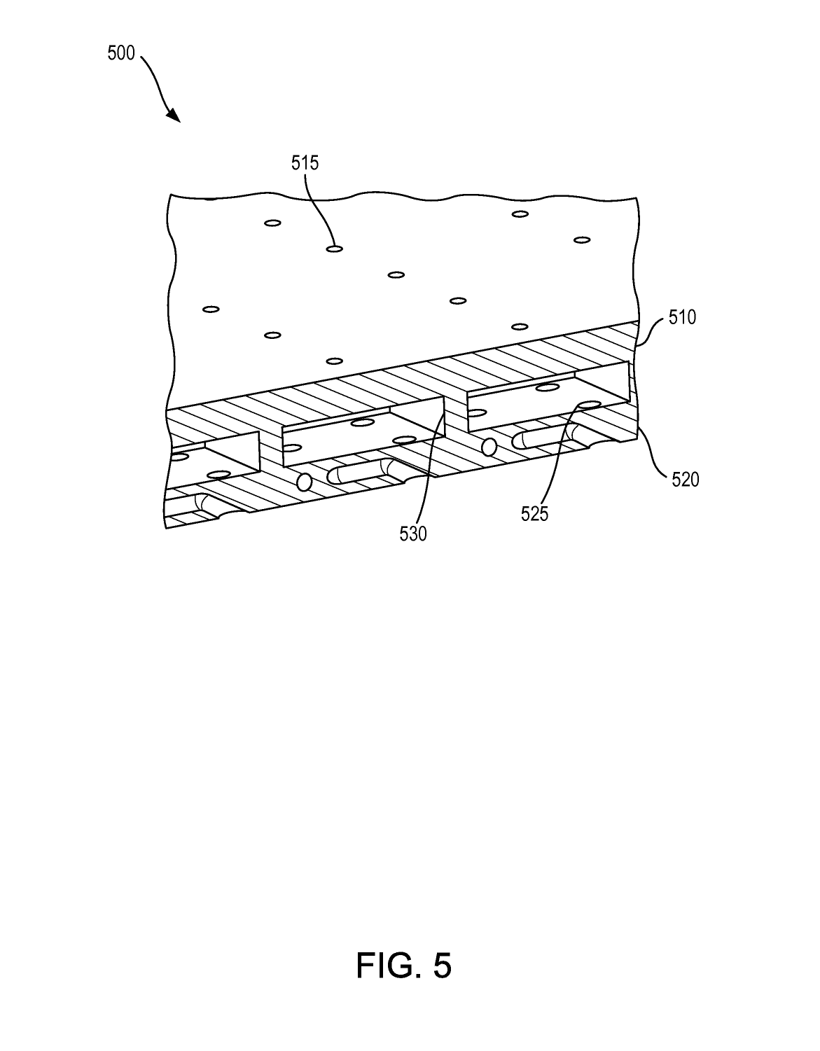

Referring to FIG. 5, a perspective view of a single-wall combustor liner 500 with segmented walls is illustrated according to various embodiments. The single-wall combustor liner 500 may comprise an outer wall 510 and an inner wall 520. The single-wall combustor liner 500 may comprise segmented walls 530. The segmented walls 530 may couple the outer wall 510 to the inner wall 520. The segmented walls 530 may be perpendicular to at least one of the outer wall 510 or the inner wall 520. In various embodiments, the outer wall 510, the segmented walls 530, and the inner wall 520 may be formed together by a DMLS process. However, in various embodiments, at least one of the outer wall 510, the segmented walls, 530, or the inner wall 520 may be independently formed and coupled to the other components by any suitable process, such as welding. The segmented walls 530 may conduct heat from the inner wall 520 to the outer wall 510 to remove heat from the combustor liner 500. The conduction may heat up the outer wall 510, and the outer wall 510 may transfer heat to cooling air flowing through the cooling holes 515. Heat may be transferred from the inner wall 520 to cooling air flowing through nonlinear cooling holes 525.

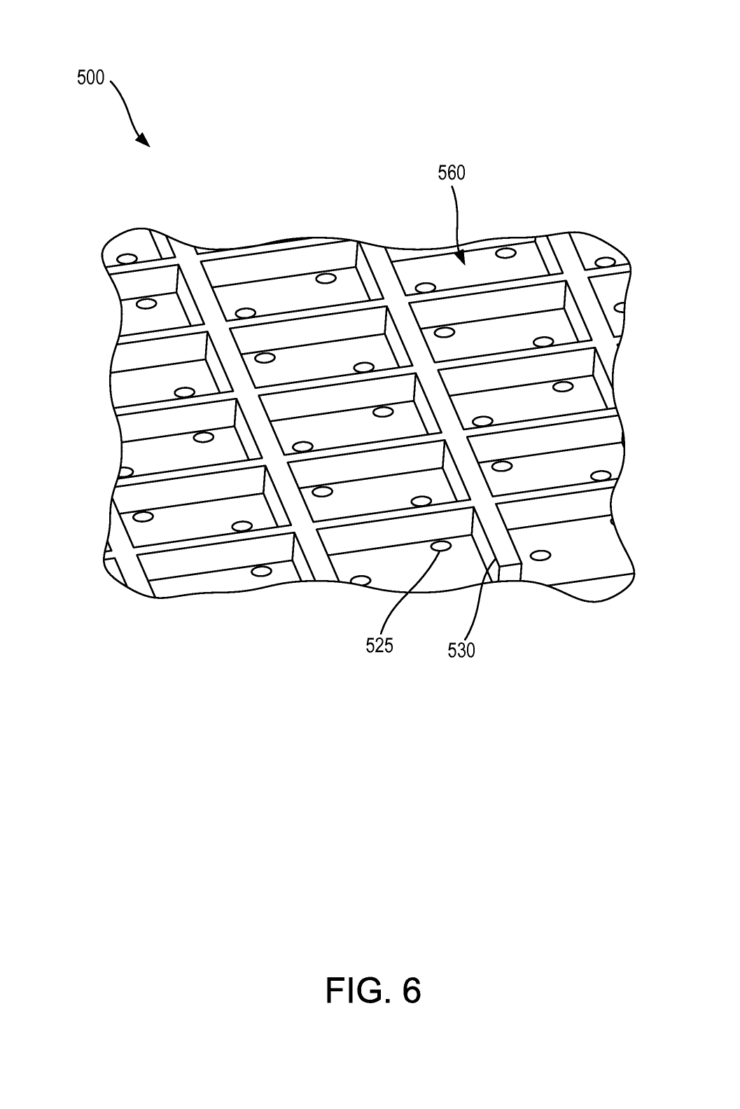

Referring to FIG. 6, a detailed view of the single-wall combustor liner 500 with the outer wall not showing is illustrated. The segmented walls 530 may form isolated segments 560. The segmented walls 530 may prevent airflow between adjacent isolated segments 560. Preventing airflow between the isolated segments 560 may cause a more even distribution of cooling air to flow through the cooling holes 525.

Those skilled in the art will appreciate that the present disclosure is not limited to the particular shapes and configurations of cooling holes and segmented walls described herein. Rather, the use of additive manufacturing allows for a variety of new shapes for cooling holes and segmented walls which improve the cooling effect in combustor liners. The particular shapes disclosed herein are merely examples of such configurations.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A gas turbine engine component comprising:
an outer surface of a first wall;
an inner surface of the first wall; and
a first cooling hole extending from the outer surface of the first wall to the inner surface of the first wall, wherein the first cooling hole is nonlinear.

2. The gas turbine engine component of claim 1, wherein the gas turbine engine component is manufactured by an additive manufacturing process.

3. The gas turbine engine component of claim 1, wherein the gas turbine engine component is a combustor liner, and wherein a length of the first cooling hole is at least twice a thickness of the combustor liner.

4. The gas turbine engine component of claim 1, wherein the first cooling hole comprises a first straight passage connected to a second straight passage by a first bend.

5. The gas turbine engine component of claim 4, wherein the first straight passage is parallel to the second straight passage.

6. The gas turbine engine component of claim 1, wherein the gas turbine engine component is a combustor liner.

7. The gas turbine engine component of claim 1, further comprising a second wall comprising an impingement hole, wherein the impingement hole is configured to direct cooling air to the first wall.

8. The gas turbine engine component of claim 7, wherein the impingement hole is a linear cooling hole.

9. The gas turbine engine component of claim 7, further comprising a segmented wall coupling the first wall to the second wall.

10. A combustor for a gas turbine engine comprising:
a first wall comprising a first cooling hole, wherein the first cooling hole comprises an inlet, a first straight passage connected to the inlet by a first bend, and a second straight passage connected to the first straight passage by a second bend.

11. The combustor of claim 10, wherein the combustor is manufactured by an additive manufacturing process.

12. The combustor of claim 10, wherein a length of the first cooling hole is at least five times a thickness of the first wall.

13. The combustor of claim 10, further comprising a second wall comprising a second cooling hole, wherein the second cooling hole is configured to direct cooling air to the first wall.

14. The combustor of claim 13, wherein the second cooling hole is a linear cooling hole.

15. The combustor of claim 10, wherein the combustor liner is a single-wall liner comprising the first wall, a second wall, and a segmented wall between the first wall and the second wall.

16. A combustor liner manufactured by an additive manufacturing process, wherein the combustor liner comprises a nonlinear cooling hole.

17. The combustor liner of claim 16, wherein the nonlinear cooling hole extends through a first wall of the combustor liner.

18. The combustor liner of claim 17, wherein a length of the nonlinear cooling hole is at least five times a thickness of the first wall.

19. The combustor liner of claim 17, wherein the combustor liner is a single-wall liner comprising the first wall, a second wall, and a segmented wall between the first wall and the second wall.

20. The combustor liner of claim 17, wherein the nonlinear cooling hole comprises:
an inlet;
a first straight passage connected to the inlet by a first bend;
a second straight passage connected to the first straight passage by a second bend;
a third straight passage connected to the second straight passage by a third bend; and
an outlet connected to the third straight passage by a fourth bend.
